(19) United States
(12) Patent Application Publication
(10) Pub. No.: US 2003/0217253 A1
(43) Pub. Date: Nov. 20, 2003

(54) Method for determining compatibility between BIOS and specified system

(75) Inventors: Ata Chen, Taipei (TW); Macalas Yen, Taipei (TW); Simon Pu, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: VIA Technologies, Inc., Taipei (TW)

(21) Appl. No.: 10/217,127

(22) Filed: Aug. 12, 2002

(30) Foreign Application Priority Data
May 16, 2002 (TW) 091110284

(51) Int. Cl. G06F 9/00

(52) U.S. Cl. 713/1

(57) ABSTRACT

A method for determining the compatibility between a basic input/output system (BIOS) and a specified system is disclosed. The method includes the steps of reading a first identifying information from the BIOS and a second identifying information from the specified system, and comparing the first identifying information with the second identifying information, and outputting a warning information when the first and second identifying information do not match with each other.

### FIELD OF THE INVENTION

The present invention relates to a method for determining the compatibility between devices, and more particularly to a method for determining the compatibility between a basic input/output system (BIOS) and a specified system.

### BACKGROUND OF THE INVENTION

As is known, various basic input/output systems (BIOSs) are used in different applications. For example, a video graphics array (VGA) BIOS cooperates with a VGA chip, and a system BIOS for main board control cooperates with a main board of a computer. Even for the same application, there are various BIOS versions in response to the different requests from different clients. A selected version of BIOS is to be packed with a compatible device, and then delivered to the client for test. Alternatively, the selected version of BIOS may be recorded in the compatible device before being delivered to the client. In either case, the identification of the BIOS version is performed manually. Hence, it is possible that the BIOS version is not consistent with the desired device because of the operator's personal carelessness. In other words, what the client received is the incorrect BIOS version.

Generally, the client will not find the mistake until the BIOS is executed. That is, this mistake will not be found unless some specific functions in the computer cannot be executed. Sometimes, such a mistake cannot be found during the test procedure, and thus the incorrect version of BIOS will be sold to the end user along with the device, which will cause a lot of troubles for the BIOS supplier, the device supplier, and even the end user.

Therefore, the purpose of the present invention is to develop a method for determining the compatibility between a BIOS and a specified system such as a VGA chip or a main board to deal with the above situations encountered in the prior art.

### SUMMARY OF THE INVENTION

An object of the present invention is to provide a method for determining the compatibility between a BIOS and a specified system such as a VGA chip or a main board of a computer upon the specified system is initialized so that the packing mistake, if any, can be made up as soon as possible.

According to an aspect of the present invention, there is provided a method for determining the compatibility between a basic input/output system (BIOS) and a specified system. The method includes the steps of reading a first identifying information from the BIOS and a second identifying information from the specified system, and comparing the first identifying information with the second identifying information, and outputting a warning information when the first and second identifying information do not match with each other.

For example, the specified system is a video graphics array (VGA) chip. In this case, the BIOS can be a VGA BIOS or a system BIOS for use with a main board of a computer for controlling the VGA chip.

Preferably, each of the first and second identifying informations includes a VGA chip identifying information and/or a customer identifying informations.

In an embodiment, the first identifying information includes a chip identifying information while the second identifying information includes a customer identifying information.

Alternatively, when the specified system is a main board of a computer, the BIOS is a system BIOS for controlling the main board.

The present method can be implemented by the BIOS or a control unit such as a BIOS recording device.

Preferably, the method is performed before installing an operating system (OS).

According to another aspect of the present invention, there is provided a method for determining the compatibility between a basic input/output system (BIOS) and a specified system. The BIOS includes a first identifying information and the specified system includes a second identifying information. The method includes the steps of comparing the first identifying information with the second identifying information, and outputting a warning information when the first and second identifying information are not consistent with each other.

In an embodiment, the specified system is a video graphics array (VGA) chip. The BIOS is a VGA BIOS or a system BIOS for VGA control of a main board of a computer. Each of the first identifying information includes a chip identifying information and/or a customer identifying information.

In another embodiment, the specified system is a main board of a computer. The BIOS is a system BIOS for controlling the main board. Each of the first and second identifying informations includes a main board identifying information and/or a customer identifying information.

### BRIEF DESCRIPTION OF THE DRAWINGS

The present invention may best be understood through the following description with reference to the accompanying drawings, in which:

FIG. 1 is a flowchart illustrating a preferred embodiment of a method for determining the compatibility between a BIOS and a specified system according to the present invention;

FIG. 2 is a flowchart illustrating another preferred embodiment of a method for determining the compatibility between a BIOS and a specified system according to the present invention; and

FIG. 3 is a flowchart illustrating a further preferred embodiment of a method for determining the compatibility between a BIOS and a specified system according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

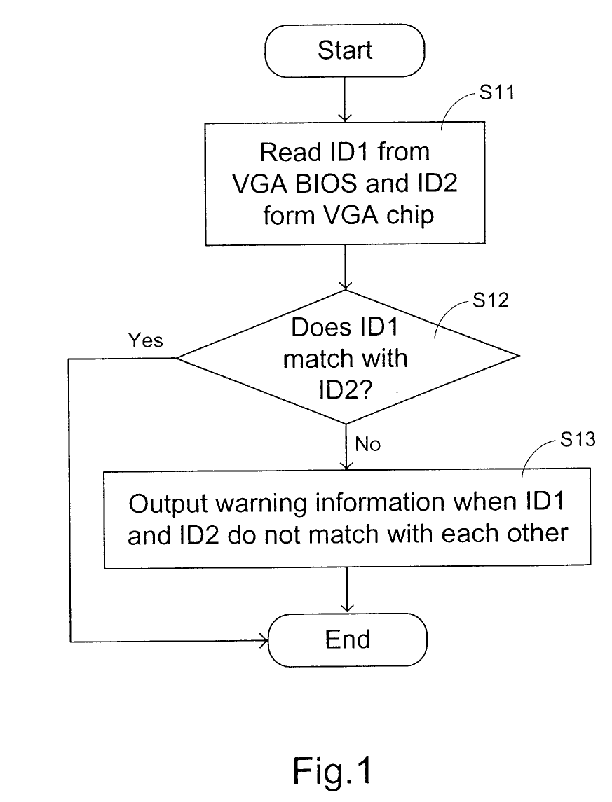

Please refer to FIG. 1 which is a flowchart illustrating a preferred embodiment of a method for determining the compatibility between a video graphics array (VGA) BIOS and a video graphics array (VGA) chip, both included in a video graphics array device. The compatibility determination is performed by the VGA BIOS or a control unit, e.g. a burning recorder for recording the VGA BIOS, before an operating system of the computer is installed. The steps of the method are described in details hereinafter.

In order to assure of the version of the VGA BIOS matches the VGA chip. A first identifying information ID1 is provided to the VGA BIOS, and a second identifying information ID2 is provided to the VGA chip. When the VGA chip is initialized, the identifying information ID1 and ID2 are read and compared with each other. If the comparing result indicates that the identifying information ID1 and ID2 are consistent or match with each other, it is determined that the version of the VGA BIOS is perfect for the VGA chip. Otherwise, there might be something wrong in the paring procedure, and thus a warning information is outputted to inform of the possible error. The warning information can be an alarm or a literal or voice message. Preferably, a VGA-chip-related information and a customer-related information are used as the identifying information ID1 and ID2. For example, ID1 is a chip identifying information, and ID2 is a customer identifying information. If they are compared, and determined not to match with each other, the warning information is given. Alternatively, each of ID1 and ID2 includes the same one or both of the chip identifying information and customer identifying information, and the consistency therebetween is checked to determine the compatibility between the VGA BIOS and VGA chip.

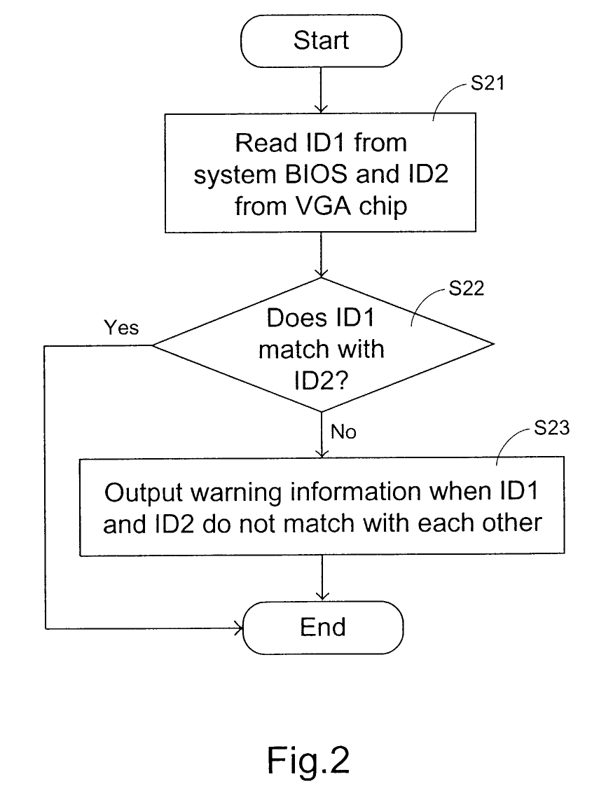

Please refer to FIG. 2 which is a flowchart illustrating another preferred embodiment of a method for determining the compatibility between a system BIOS and a VGA chip. The system BIOS is used with a main board of the computer for controlling the VGA chip. In this embodiment, the first identifying information ID1 is provided to the system BIOS, and the second identifying information ID2 is provided to the VGA chip. When the comparison between ID1 and ID2 performed when the VGA chip is initialized indicates a dis-match or an inconsistent result, a warning information is sent.

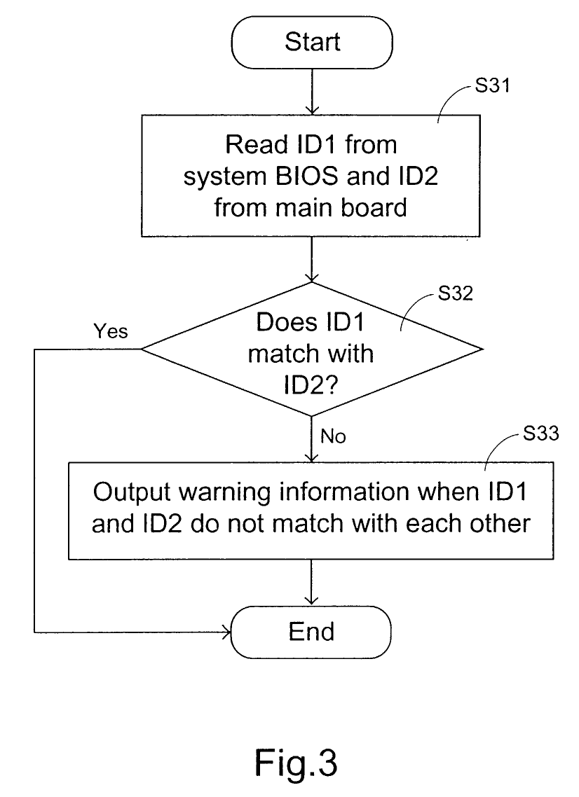

The method according to the present invention can also be used to determine the compatibility between a main board of the computer and a system BIOS for controlling the main board. The flowchart is shown in FIG. 3. In this embodiment, the identifying information ID1 and ID2 to be compared when the host computer is initialized are provided to and read from the system BIOS and the main board of the computer, respectively. Likewise, the warning information is optionally sent out according to the comparing result.

To sum up, whether the installed version of the BIOS is compatible with the VGA chip or the main board can be determined when the VGA chip or the main board is initialized or the BIOS is recorded to the VGA chip or the host computer by the BIOS recording device. Therefore, the method according to the present invention can find the inconsistency problem and make some change once the VGA chip of the host computer is initialized, and thus make up the mistake in an early stage.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for determining the compatibility between a basic input/output system (BIOS) and a specified system, comprising the steps of:
reading a first identifying information from said BIOS and a second identifying information from said specified system; and
comparing said first identifying information with said second identifying information, and outputting a warning information when said first and second identifying information do not match with each other.

2. The method according to claim 1 wherein said specified system is a video graphics array (VGA) chip.

3. The method according to claim 2 wherein said BIOS is a VGA BIOS.

4. The method according to claim 2 wherein said BIOS is a system BIOS for use with a main board of a computer for controlling said VGA chip.

5. The method according to claim 2 wherein each of said first and second identifying informations includes a VGA chip identifying information and/or a customer identifying informations.

6. The method according to claim 1 wherein said first identifying information includes a chip identifying information while said second identifying information includes a customer identifying information.

7. The method according to claim 1 wherein said specified system is a main board of a computer.

8. The method according to claim 7 wherein said BIOS is a system BIOS for controlling said main board.

9. The method according to claim 8 wherein each of said first and second identifying informations includes a main board identifying information and/or a customer identifying information.

10. The method according to claim 8 wherein said first identifying information includes a main board identifying information while said second identifying information includes a customer identifying information.

11. The method according to claim 1 wherein said method is implemented by one of said BIOS and a control unit.

12. The method according to claim 11 wherein said control unit is a BIOS recording device.

13. The method according to claim 1 wherein said method is performed before installing an operating system (OS).

14. A method for determining the compatibility between a basic input/output system (BIOS) and a specified system, said BIOS including a first identifying information and said specified system including a second identifying information, said method comparing said first identifying information with said second identifying information, and outputting a warning information when said first and second identifying information are not consistent with each other.

15. The method according to claim 14 wherein said specified system is a video graphics array (VGA) chip.

16. The method according to claim 15 wherein said BIOS is one of a VGA BIOS and a system BIOS for VGA control of a main board of a computer.

17. The method according to claim 15 wherein each of said first identifying information includes a VGA chip identifying information and/or a customer identifying information.

18. The method according to claim 14 wherein said specified system is a main board of a computer.

19. The method according to claim 18 wherein said BIOS is a system BIOS for controlling said main board.

20. The method according to claim 18 wherein each of said first and said second identifying information includes a main board identifying information and/or a customer identifying information.
